(19) United States
(12) Patent Application Publication
(10) Pub. No.: US 2006/0121594 A1
(43) Pub. Date: Jun. 8, 2006

(54) Refining process and apparatus

(76) Inventors: Mike Everton, Victoria (AU); John Herschel Isaacs, Victoria (AU)

Correspondence Address: STANDLEY LAW GROUP LLP, 495 METRO PLACE SOUTH, SUITE 210, DUBLIN, OH, 43017, US

(21) Appl. No.: 10/511,509

(22) PCT Filed: Apr. 16, 2003
(86) PCT No.: PCT/AU03/00451

§ 371 Date: Jan. 25, 2006

(30) Foreign Application Priority Data
Apr. 16, 2002 (AU) PS 1775

(51) Int. Cl. A62D 3/00

(52) U.S. Cl. 435/262.5; 588/313; 588/405

(57) ABSTRACT

An apparatus and method is provided for treating a waste material, particularly an aqueous waste material containing fats, oils and greases (FOG), involving the use of at least two stages in which, in the first stage, the aqueous waste material is subjected to a separation step in which water is removed to leave a partially refined stream containing the FOG followed by a second treatment stage, in which the partially refined FOG stream is further refined by removing more of the water so as to produce a FOG-containing stream that has a low water content which can be used as a fuel. In one embodiment, the refined FOG is used as a fuel for a combustion engine, typically a hydrogen assisted combustion engine for generating electricity. The energy generating plant can be combined with the waste treatment plant or the two can be separated from each other. One of the characteristics of this invention is that the water removed from the waste material can be recycled for use in the process, thereby providing energy saving as the introduction of fresh steam is not continuously required.

The present invention relates generally to the treatment of waste material, particularly to the treatment of waste materials produced from industrial, commercial or domestic processes, such as for example, chemical waste material resulting from manufacturing processes, food preparation and cooking processes or the like. More particularly, the present invention relates to a method and apparatus for separating useful components or recoverable materials from chemical waste material produced in manufacturing or other processes by refining the waste material to remove unwanted materials, particularly unwanted chemical materials, so that the recovered useful components can be used, recycled or further processed and optionally reuse the unwanted materials by recycling or reprocessing the unwanted materials. Even more particularly, the present invention relates to refining chemical industrial wastes of the type containing fats, oils and greases or the like (FOG) to recover the FOG materials so that they can be reused, particularly as a fuel, such as a non bio-diesel fuel, in a range of combustion engines for a variety of different purposes, such as for example, in power generation installations within an industrial complex, for the generation of electricity for use in supplying power to communities, for use in industrial plants or for feeding electricity back into the normal grid of the electricity supply of a state, city, region, town or the like. The present invention finds particular application as a cost effective way of disposing of aqueous mixtures of greasy waste materials so that the refined or recovered materials obtained from treating the greasy waste material can be used as either a fuel or as one component of a fuel in engines, such as internal combustion engines, compression engines, hydrogen assisted combustion engines or the like for generating electricity, power, heat or other energy requirements whilst optionally the unwanted water can be reused, reprocessed or recycled as steam in the overall processing according to this invention. The useful components of the greasy waste are obtained by refining the greasy waste material to recover the useful materials, such as the fats, oils and greases from fast food outlets or the like, and then separating the water from the greasy materials. The separated water can also be used in other processes, including the process of the present invention, by recycling the water and/or recovering heat from the water steam obtained from the process.

Although the present invention will be described with reference to one particular example of the present invention which involves the recovery of fats, oils and greases from the waste of fast food outlets using one form of separation apparatus to provide refined products for use as fuels, it is to be noted that the scope of the present invention is not limited to the described embodiment but rather the scope of the present invention is more extensive so as to include the treatment of a wide variety of diverse materials including materials other than fats, oils and greases emanating from fast food outlets, treating materials obtained from a variety of different sources and the use of other types of separation apparatus, and methods or processes other than the recovery of fats, oils and greases, including processes that recover water from the waste materials.

The amount of industrial processes, including manufacturing processes, such as for example, the preparation of foods and beverages including fast foods, such as chicken meals, hamburgers or the like is increasing so that increasing amounts of waste products are being formed as a result. The waste material emanating from such processes contains potentially useful or valuable materials. In the past, the waste material was dumped or otherwise disposed of leading to the loss of valuable resources and to the wastage of materials which potentially could be recovered and reused.

The dumping of these materials in landfill and other environmentally sensitive areas contributed to the inefficient use of valuable resources and to the cost of the overall manufacturing or preparation process since the cost of dumping the waste materials needed to be taken into account when costing the product being produced by such processes, and also the cost of the process could not be offset by the subsequent use or reuse of any recovered products, including both the useful component and the unwanted or contaminating products.

Furthermore, the indiscriminate dumping of waste materials is environmentally unacceptable and introduces a further range of problems including contamination of ground water and the like. Thus, the dumping of waste materials is neither economically nor environmentally desirable.

In the past whilst it had been recognized that the waste materials could be treated so as to recover valuable components from the waste material, the technology for efficiently recovering the useful components was either not available or was too expensive to operate to be cost effective resulting in the treated materials being too expensive for economical reuse or further processing or the like. Furthermore, the use or production of renewable energy is now assuming greater importance within industries which want to be described as being environmentally sustainable or at least compatible with the environment. Presently, fat, oil and grease from grease traps is difficult to treat and/or re-process at a cost that results in a viable product, such as for example, the production of tallow for use in the cosmetic industry and/or in other industrial processes. Therefore, there is a need for a more efficient and cost effective method of processing ‘grease’ type products that are obtainable from grease traps, sumps, pits, or the like, to recover useful components from these “grease” materials.

There is also a need for a method and apparatus for treating waste materials to recover useful components in a form that allows the useful components to be used, recycled or further processed in such a way that the operation of the method and apparatus is economically viable and/or the value of the recovered products makes their reuse economically viable.

The present invention sets out to address these problems by providing a method and apparatus which is economic in operation, which is efficient and which results in valuable components of a waste material being recovered in a form that allows the recovered products to be used economically, and optionally, which uses or recycles unwanted materials, such as for example, the excess water of the aqueous waste material mixtures.

In particular, the present invention finds particular application in treating aqueous mixtures of waste materials containing fats, oils, greases, solids and the like so as to recover the fat, oil and grease components in which the recovered components are in a form or are of a purity that allows the recovered components to be readily reused, such as for example, in a fuel, and optionally allows the excess water to be reused or recycled, such as for example, as steam to transfer heat in one or more of the various steps in the overall refining process.

According to one aspect of the present invention, there is provided a method of treating a waste material having or containing at least one useful component to separate the useful component from the remaining components of the waste material including relatively volatile components, including the steps of at least introducing the waste material into a first treatment stage to at least partially separate the waste material into at least two portions thereby partially separating the useful component from the remaining volatile components of the waste material to form a partially refined portion of the useful component, conveying the at least partially refined portion to a second treatment stage to further separate the partially refined portion into at least two further portions wherein one of the further portions contains the useful component and another of the further portions contains the volatile portion, thereby further refining the partially refined portion into a substantially refined portion containing the useful component and collecting the substantially refined portion containing the at least one useful component wherein the at least one useful component can be used, recycled or further processed to improve the efficiency or economics of the refining process or the use of the waste material.

According to another aspect of the present invention, there is provided a method of treating a waste material having or containing at least one useful or reusable component and a relatively more volatile component so as to recover the useful or useable component from the waste material by removing the relatively more volatile component, including the steps of:

at least introducing the waste material into a first treatment stage to at least partially remove the relatively more volatile component from the whole material by forming at least two portions in which one of the portions is a partially refined portion containing the useful component and the other portion contains the relatively more volatile component;

conveying the partially refined portion to a second treatment stage to further separate the partially refined portion into at least two further portions wherein one of the further portions includes the useful component and the other further portion is substantially free of the useful component so that the partially refined portion is refined into a substantially refined portion;

collecting the substantially refined portion, wherein the substantially refined portion is in a condition that is suitable with or without further treatment for use as an energy source.

According to a further aspect of the present invention, there is provided a method of generating energy from a waste material, including treating the waste material to recover a useful or useable component of the waste material in a condition that is suitable, optionally with further treatment, for use as an energy source, conveying the useful or useable component to an energy generating device or installation and using the useful or useable component to generate energy by operating the energy generating device wherein the treatment of the waste material includes treating a waste material having or containing at least one useful or reusable component and a relatively more volatile component so as to recover the useful or useable component from the waste material by removing the relatively more volatile component, including the steps of:

at least introducing the waste material into a first treatment stage to at least partially remove the relatively more volatile component from the whole material by forming at least two portions in which one of the portions is a partially refined portion containing the useful component and the other portion contains the relatively more volatile component;

conveying the partially refined portion to a second treatment stage to further separate the partially refined portion into at least two further portions wherein one of the further portions includes the useful component and the other further portion is substantially free of the useful component so that the partially refined portion is refined into a substantially refined portion;

collecting the substantially refined portion, wherein the substantially refined portion is in a condition that is suitable with or without further treatment for use as an energy source.

Typically, the method of the present invention includes using the at least one useful component and/or using the unwanted component or the volatile component to increase the economic viability of the overall process of this invention by reusing or recycling or reprocessing the useful component and/or unwanted component and/or volatile component.

More typically, the process of the present invention includes an additional step, wherein at least one of the portions being substantially free or partially free of the useful component can be used, recycled or further processed to improve the efficiency or economics of the refining process.

Typically, the unwanted portion or volatile portion is recycled from the first separated portion produced from the first treatment stage or is recycled from the second separated portion from the second treatment stage or from both the first and second treatment stages.

Typically, there is a first auxiliary or secondary separation stage. More typically, the first auxiliary or secondary separation stage includes the use of a separation apparatus or device. Even more typically, the separation apparatus or device is a separator, such as for example, a separator pot.

Typically, there is a second auxiliary or secondary separation stage. More typically, the second auxiliary or secondary separation stage involves the use of a separation apparatus or device. Even more typically, the separation apparatus or device is a separator, such as for example, a separator pot.

Typically, the unwanted portion or volatile portion is recycled from the first auxiliary separation step or from the second auxiliary separation step or from the first and second auxiliary steps.

Typically, the useful or useable material or the waste material is hydrophobic material. More typically, the hydrophobic material is an oil or oleo material or an oil-like material or is non-miscible or partly miscible with water.

Typically, the waste material is an aqueous mixture containing water and the hydrophobic materials. More typically the waste material is an aqueous mixture containing fats, oils, greases, solids and the like. Even more typically the waste material contains up to about 20%, preferably up to about 30%, more preferably up to about 40% and most preferably up to 50% of fats, oils, greases. Even more typically, the waste material contains up to 5%, preferably up to 4%, and more preferably about 2% of suspended solids and up to 80%, preferably at least about 60%, more preferably at least about 58%, and most preferably at least about 50% of water.

Typically, the unwanted material or relatively more volatile component is water so that this component is removed in the form of water vapor and/or steam by heating, particularly in a separator. Other impurities or similar can also be removed along with the water steam.

Typically, the first treatment stage is a separation stage. More typically, the separation stage includes a separation apparatus or device. Even more typically, the separation apparatus or device is a cyclonic evaporator in which the introduced waste material is separated into a first portion or stream which is a substantially water vapor or water stream and a second portion or stream which is a combination of water, water vapor and useful component, ie., is a portion containing the useful components, including fats, oils, greases and the like, together with some water.

Typically, the second treatment stage is a second separation stage. More typically, the second separation stage includes a separation apparatus or device. Even more typically, the separation apparatus is a cyclonic evaporator. More typically, further water or steam is separated from the partially refined waste material stream obtained from the first separation stage to form a substantially refined stream in the cyclonic evaporator in which the substantially refined stream includes the useful component. Typically, small amounts of water can be tolerated in the substantially refined stream.

Typically, the separation device used in one or more of the at least four separation steps, being the first and second treatment stages and the first and second auxiliary stages is a separator. More typically, the separator is an evaporator or a separation pot. Even more typically, the evaporator is a Calandria evaporator, a LTV rising film evaporator, a LTV falling film evaporator, a force circulation evaporator, a hydro-cyclone evaporator or the like. Even more typically, the evaporator is a Calandria Cyclovap evaporator.

Typically, the useful component is a fat, oil or grease or other essentially oleo type material or hydrophobic type material that is combustible. More typically, the useful component and/or refined product is a fuel or a component of a fuel or is capable of being used as a fuel. More typically, the fuel is suitable or adapted or modified as a fuel for an engine. Even more typically, the useful component can be additionally treated to enhance its properties as a fuel or fuel component.

Typically, the waste material is dewatered prior to introduction into the first treatment stage. More typically, the waste material is collected as grease trap waste and is dewatered to contain about 40% grease, 2% solids and 58% water.

Typically, the engine in which the recovered or refined component is used as a fuel or as one component of the fuel is an internal combustion engine, a compression engine or a hydrogen assisted combustion engine. More typically, the engine is used to generate electricity or power.

Typically, the first separation step results in two portions being formed, in which one of these portions is a mixture of the useful component and water, whereas the other portion is essentially a water portion, either as liquid water or water vapor which can optionally include other volatile materials.

Typically, two portions are formed in the second separation step, in which one of the portions is substantially the useful component of fats, oils and greases or the like, whereas the other portion is essentially water in either liquid or vapor form with or without other volatile materials.

Typically, the first auxiliary separation step results in two portions being formed, in which a first portion is a mixture of the useful component and water, whereas the second portion is essentially water in vapor form.

Typically, the second auxiliary or secondary separation step results in the formation of two portions, in which the first portion is essentially for the useful component with some water, whereas the other portion is essentially water vapor.

Typically, one, two, three, four or more of the separate portions containing or comprising water formed in the individual separation apparatus or devices are recycled, such as for example, vapor or water being returned to the installation, particularly at an elevated temperature.

The present invention will now be described by way of example with reference to the accompanying drawings in which

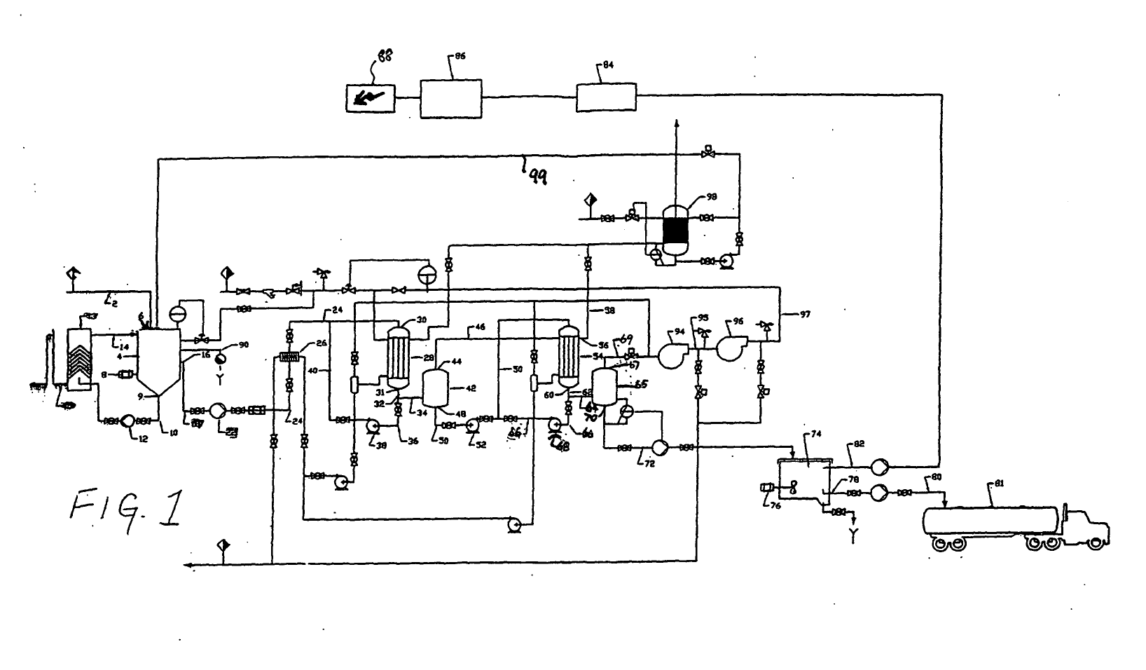

FIG. 1 which is a flow-chart schematically illustrating one form of the process of the present invention,

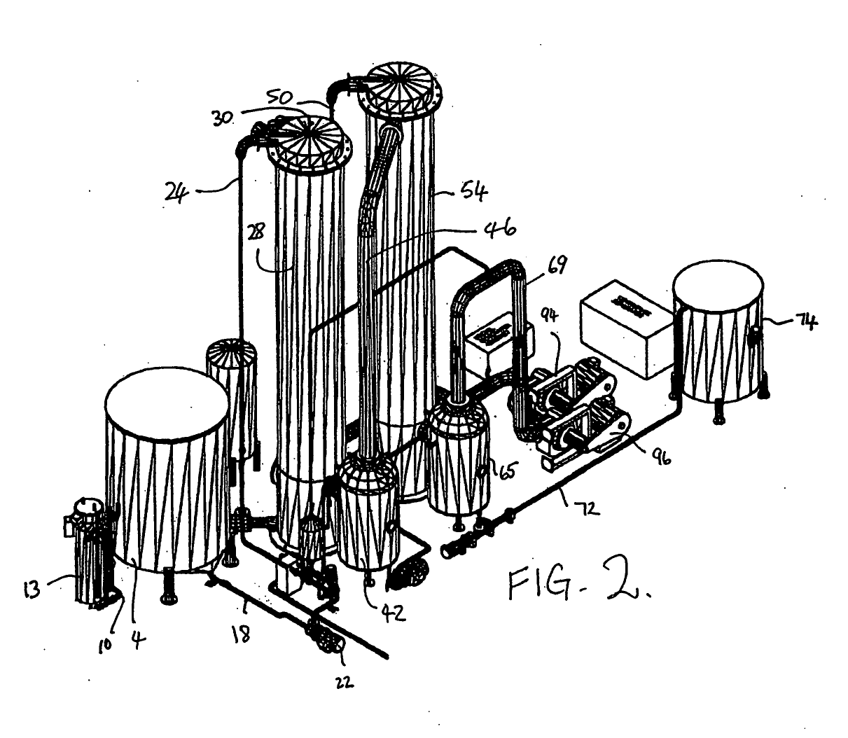

FIG. 2 is a schematic top perspective view of one arrangement of the apparatus for carrying out the process of the present invention in accordance with the flow chart of FIG. 1.

Waste, typically in the form of greasy waste, from manufacturing processes including food and beverage manufacturing processes, food preparation processes, including restaurants, fast food preparation establishments, and other commercial, industrial or domestic installations is collected and optionally stored, such as for example in a holding tank (not shown). The holding tank may be located at the establishment or at some other location. The waste is typically in the form of an aqueous mixture containing water along with the useful or useable components that are to be recovered. A conduit 2 is connected to the holding tank or extends directly from a transportation tanker or similar (not shown) for delivering incoming waste, particularly an aqueous mixture of grease or related products obtained from a commercial food preparation establishment as waste. Waste in conduit 2 is conveyed to a heated feed tank 4 provided with an inlet 6 for receiving the greasy waste, and a side mounted agitator or stirrer 8 for agitating the heated contents of tank 4 in order to keep the contents of the tank liquid and mobile to facilitate subsequent transportation and treatment of the waste material.

Tank 4 is provided with a recycling outlet 9 and conduit 10 for recirculating waste products initially unsuitable for recovery or treatment through cavity feed pump 12 to a separation apparatus, such as for example a vertical gravity separator (VGS) provided by Acqua International (Australia) Pty Limited, or similar separator 13 for separating oil and water from the greasy waste for returning to tank 4 through conduit 14. In this manner, initially unsuitable material can be altered so it is now suitable for subsequent treatment by the process of this invention. If desired, the waste material can be recirculated through separator 13 to maintain the material in a mobile condition as a preliminary step to treating the waste material. Clean water is discharged in a suitable or convenient manner from VGS 13, such as for example, through outlet and conduit 15 for disposal in an environmentally acceptable manner or for use in the process of the present invention or in some other process to assist the economical operation of the overall waste treatment of this invention.

Tank 4 is provided with a side mounted outlet 16 extending from the side of tank 4 for discharging heated waste from tank 4 and a conduit 18 for conveying the heated waste through conduit 18 by pump 22. A conduit 24 extends from pump 22 through heat exchanger 26 to transport waste material to the first treatment stage, such as to the top of a first separating apparatus in the form of a cyclonic evaporator, known as a cyclovap calandria 28 or similar provided by Acqua International (Australia) Pty Limited which uses steam to separate water from the oil like useful components of the waste material. It is to be noted that any suitable device can be used. The greasy waste is admitted to calandria 28 through inlet 30 located at or towards the top of the calandria. Separation of the water and oleophilic material such as fats, oils, greases and the like takes place in calandria 28. Calandria 28 is provided with a waste outlet 31 located at or towards the base of the calandria. A conduit 32 extends from outlet 31 of calandria 28. Conduit 32 is divided into a further conduit 34 leading to a first separator tank pot vessel 42 or the like and a second conduit 36 leading via cyclovap re-circulation pump 38 and conduit 40 back to conduit 24 between heat exchanger 26 and calandria 28 for recycling greasy waste material not separated in cyclovap calandria 28 back into the calandria 28 for further processing and separation. In this first treatment zone, there is partial separation and refining of the waste material occurring in calandria 28 in a first portion by removal of some of the water in the form of steam from the aqueous waste material admitted to the calandria, leaving a second portion which is the remaining waste material containing the useful component or components along with a reduced amount of water.

Conduit 34 is connected to the inlet of the first of the auxiliary or secondary separation devices in the form of a separator pot 42 where the mixture of steam and FOG emanating from calandria 28 is further separated into two further portions which are firstly a vapor stream which is discharged through outlet 44 of separator pot 42 and a second portion containing the useful components. The first portion of water vapor is conveyed by conduit 46 for subsequent processing or use, including recycling as will be described in more detail later in this specification. The other portion of separated fats, oils and greases is discharged through outlet 48 of separator pot 42 into conduit 50 by means of pump 52 and conveyed to the second treatment stage, such as by being conveyed to the top of a second calandria or cyclonic evaporator or similar apparatus 54 which can be the same as the first calandria 28. First outlet 56 of calandria 54 is for use in conveying steam through conduit 58 for subsequent use, re-use or processing. A second outlet 60 is located at or towards the base of calandria 54 for discharging separated fat, oil, grease, and the like through conduit 62. Conduit 62 divides into a first conduit 64 and a second conduit 66. Second conduit 66 is for recycling FOG through cyclovap re-circulation pump 68 and conduits 66 and 50 for re-admission to the top of calandria 54 for subsequent processing to further refine the FOG of the waste material if necessary.

Conduit 64 conveys FOG to a second auxiliary or secondary separation device in the form of a separator pot, tank vessel or the like 65 where further separation of steam and refined FOG takes place. Steam is discharged from pot 65 through outlet 67 and conduit 69 for use, re-use or subsequent processing.

Another outlet 70 is located at or towards the base of separator 65 for discharging refined fats, oils and greases which are conveyed through conduit 72 to a final product holding tank 74 fitted with a side mounted agitator stirrer 76 or similar for agitating the contents of the final product holding tank.

In one embodiment holding tank 74 is provided with a first outlet 78 and a first conduit 80 for discharging hot refined product from final product holding tank 74 to a road tanker 81 or similar vehicle or the like for transporting refined product to a remote location for subsequent use or further processing. In this embodiment the refined product may be used in a variety of different ways. One way is as fuel for a variety of uses including heating oil, fuel for an internal combustion or compression engine or the like.

In another embodiment holding tank 74 is provided with a second outlet and conduit 82 for conveying refined product to a centrifical separator 84 where the refined product is further refined so as to remove any solid impurity or other contamination before the fully refined product is conveyed to a diesel engine 86 or similar for generating electricity or power. In one embodiment the power is used to operate the refining installation of the present invention. In another embodiment the generator is used to produce electricity for an industrial, manufacturing or commercial plant, community or similar, or a combination of different uses, all requiring the generation of electricity. Control panel 88 controls the distribution of electricity.

In one preferred form of the present invention the refined product is used as the fuel or as one component of the fuel of a diesel engine generator or a engine using hydrogen assisted combustion for generating power. It is particularly advantageous to use the refined product as a fuel in a hydrogen assisted combustion engine for generating power, most suitably in the form of electricity, for providing energy for an industrial complex, community or the like.

In one embodiment conduit 82 is provided with a heat exchanger (not shown) using the steam generated from the refining of the FOG to further heat the refined product before admitting the product to the diesel generator or similar to assist the efficiency of combustion.

In operation of one form of the installation of the present invention which is that form illustrated in FIGS. 1 and 2 of the accompanying drawings, the greasy waste admitted to tank 4 through conduit 2 is typically of a composition up to about 50% oil or oleophilic-type products which includes one or more useful components that is to be recovered and an amount, typically greater than about 50% of water. A particularly typical composition of waste material is about 40% grease or other hydrophobic type components, 2% solids, and 58% water. This material is heated in tank 4 to a temperature of about 90° C. so that the waste material is mobile. Tank 4 is agitated by stirrer 8 to provide a substantially homogeneous mixture of waste material thereby preventing pre-separation of the FOG from the water prior to treatment of the waste mixture in the first treatment stage, such as prior to entering the first calandria 28. The waste material is pumped by pump 22 through heat exchanger 26 into the first calandria 28 of the first treatment stage where a first phase separation occurs by vaporising some of the water of the waste material in order to remove some of the water component from the waste material. The water vapor is removed from calandria 28 and is directed to any suitable location in the overall process, such as for example, to aroma tank 98. The partially refined stream of waste material now depleted of water is discharged from calandria 28 by being pumped into separator pot 42 where it is further treated by removing more water as water vapor before being pumped to calandria 54 for the second treatment stage. In calandria 54, the moisture content of the waste material is further depleted by removing water as vapor so that the water content of the refined waste material has been reduced to about 5%. The concentrate of the refined product in the stream which is discharged through outlet 60 of second separator 54 is about at least 95% oil/grease and similar products, ie., contains little water. The stream of refined product which is discharged from the second auxiliary separation device, in the form of separation pot 65, is at about 95° C. and is conveyed to holding tank 74 which is maintained at a temperature of about 70° C. where the refined oil product is stored at this elevated temperature. If the refined oil product is used directly from final product holding tank 74, it can be passed through a suitable heat exchanger (not shown) to reduce the temperature further before being used as a fuel or similar, if necessary. Alternatively, this material can be treated in any way to enhance its properties for use as a fuel or similar.

In one embodiment steam emanating from either or both of the first and second calandria 28, 54 is conveyed to a suitable apparatus, such as for example an aroma tank 98 for converting to water for subsequent recycling or further processing or the steam may be pumped under pressure to holding tank 4 via conduit 99 where it is used to dilute the concentration of fats, oils and greases in the holding tank so that the composition of the waste material is suitable for treatment by the process of this invention. In another embodiment, still further portions of the steam are used to heat the contents of the holding tank by passing the steam through a heat exchanger associated with the holding tank, such as for example, by being located to one side of holding tank 4, as shown in FIG. 1 with reference to heat exchange 90.

In further operation of the apparatus and method of the present invention vapour separated in first separation pot 42 is collected and passed through outlet 44 to conduit 46 to second calandria 54. Vapour being discharged through outlet 60 of calandria 54 is conveyed by conduits 62,64 to second separation pot 65 where it is discharged through outlet 67 and conveyed via conduit 69 to a first radial compression fan 94 which increases the temperature from about 95° C. to 100° C. or higher. The heated vapour being discharged from first radial compression fan 94 is passed to the inlet of a second radial compression fan 96 through conduit 95. The vapour after passing through the second radial compression fan 96 is discharged at a temperature between 100° C.-110° C. into conduit 97. The steam from the second recompression fan 96 is conveyed by conduit 97 for re use in first calandria 28 thus commencing the separation and refining process once again for a further amount of incoming waste material. By using recompression fans the need for continuous steam is eliminated thus reducing dramatically the cost of operating the apparatus and method of the present invention by obviating the need to supply fresh preheated steam to the method and apparatus.

Steam or vapour discharged from first calandria 28 and second calandria 54 is conveyed by conduits such as conduit 58 to the aroma tank 98 for subsequent treatment, such as for example recycling to holding tank 4 via conduit 99 or venting to atmosphere or condensation to form a water supply for a variety of uses including subsequent steam generation.

Furthermore, other modifications of the steam/water vapour/water processing and use of the present invention are contemplated such as the condensation of steam to form demineralised water and the production of steam for other uses.

Another modification of the present invention includes incorporating a vertical gravity separator (VGS), similar to VGS 13, at a restaurant or take away food establishment for separating much of the fat, oil and grease from the waste water on site so as to reduce the amount of water that has to be transported from the restaurant or similar to the treatment location where the installation process of the present invention is carried out or is located. Using a vertical gravity separator or similar it is possible to obtain about a 50% reduction in the amount of water being collected and transported with the waste material. The reduction in the amount of water being collected and transported dramatically reduces the transportation cost to a transport company. As an example, instead of previously having to use one suction truck to empty a grease trap by collecting 2,000 litres of waste material that is predominantly water each month, it is possible to remove 200-300 litres of grease every two months since there is very little water included in the waste material. By utilising the VGS at the restaurant or similar it is possible to reduce the need to process up to 90% of the water being discharged from the restaurant or similar. This would allow each truck to collect concentrated grease from each pick up point thereby allowing 10-15 collections of concentrated grease per trip rather than being limited to only two collections per trip because of the large volume of water also being collected. Once the waste material is delivered to the site where the installation of the present invention is located it would undergo a pretreatment by heating the waste material and filtering the material to remove any solids having a particle size of greater than 2 mm. The pre treated waste material would then be treated in accordance with the present invention by being admitted through conduit 2 and so on through the apparatus as described. If necessary, additional water could be added to the waste material. Typically, this additional water is recycled from the process of this invention.

In another embodiment of the present invention which embodiment uses the refined product produced by the method of the present invention as a fuel, the recovered FOG is delivered to an engine installation having the following characteristics. The refined product is made available at about 70° C. having less than 3% moisture and containing particles of no more than 2 micron or less and a calorific value of between about 35 and 41 mgl/kg.

In this embodiment the refined oil is transferred to a jacketed fuel tank at a predetermined temperature such as eg. 70° C., to maintain the oil product liquid and mobile. The tank is heated with steam or hot water to facilitate cold starting of the engine if necessary or to maintain a working temperature for an operating engine. The refined oil is passed to a trimming heat exchanger to trim the temperature of the oil to the optimum temperature for direct injection into the combustion engine for optimum ignition during operation of the engine. The actual temperature of the refined oil product is selected so as to be compatible with the operation of components such as the injector pump, the injector head and the like.

Optionally, the fuel lines for delivering fuel to the engine are heated or modified or lagged to ensure that the lines do not gum up or become clogged or otherwise become restricted during prolonged use of the engine by the solidification of the refined oil product in such fuel lines when used as the fuel. The refined oil passes through a normal fuel filter system. The amount of fuel injected into the engine is in accordance with many parameters including the calorific value of the refined oil product and the requirements of the engine.

Further, the engine can be optionally provided with a mixer such as for example a HACT mixer or similar allowing hydrogen to be added to the total fuel/air mixture for admission to the cylinders of the engine prior to ignition. It is expected that the use of the oil product refined by the method and apparatus of the present invention will provide a fuel consumption of about 30-35 litres of oil per hour.

The exhaust from combustion within the engine is passed through a scrubber to remove any ash or odours in order that the engine will satisfy current emmission standards.

Furthermore, a further installation can be provided in the exhaust system of the engine, so as to extract extra heat from the exhaust gases. The installation uses the exhaust gases in a similar manner to that of a turbo charger to generate additional energy, such as in the form of power, heat or electricity, by being coupled to a suitable generator. In this manner the waste heat of the exhaust gases can be converted into useable power, heat, steam or the like.

It is to be noted that other forms of separators, including other forms of evaporators, can be used in the process of the present invention.

Advantages of the present invention include the following:

Fats, oil and greases can now be treated economically, whereas previously waste materials containing these useful products were discarded which incurred a cost rather than being a saleable or marketable product for recouping costs.

Recycling and/or recovery of the fats, oil and greases is more environmentally acceptable than merely discarding these materials to landfill or the like.

Operation of the process of the present invention allows one of the hitherto unwanted materials, namely water and/or steam, to be recycled and used as part of the process, whereas previously available methods merely separated the water from the FOG materials and discarded the water to waste. Recycling of water, particularly in the form of steam, reduces the amount of energy required to operate the process which in turn reduces the cost of supply energy since the heat of the steam is recoverable in selected steps of the overall process. Furthermore, the steam can be reused in a number of different stages in the overall process.

The refined/recovered fats, oil and greases are sufficiently pure and/or are in a condition that allows these materials to be used as a fuel or as a component of a fuel, thereby providing further savings to the energy requirements of the process or producing energy where previously it was not possible or at a much higher cost.

The process of the present invention allows a compact combined waste treatment and energy production installation to be located at or within the one site, since the product stream from the waste treatment containing the refining FOG materials can be supplied as a fuel directly to an engine/generator for producing energy in the form of heat, electricity or the like.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A method of treating a waste material having or containing at least one useful or reusable component so as to recover the useful or useable component from the remaining components of the waste material, including the steps of at least introducing the waste material into a first treatment stage to at least remove a relatively more volatile component from the waste material by forming at least two portions in which one of the portions is a partially refined portion containing the useful component, and the other portion contains the relatively volatile component, conveying the at least partially refined portion to a second treatment stage to further refine the partially refined portion into at least two further portions, wherein one of the further portions includes the useful component and the other of the further portions includes the relatively more volatile component, thereby further refining the partially refined portion into a substantially refined portion and collecting the substantially refined portion containing the at least one useful or useable component, wherein at least one of the portions containing the relatively more volatile component that is substantially or partially free of the useful component can be used, recycled or further processed to improve the efficiency or economics of the refining process for the useful or useable component or the use of the waste material.

2. A method of treating a waste material having or containing at least one useful or reusable component and a relatively more volatile component so as to recover the useful or useable component from the waste material by removing the relatively more volatile component, including the steps of:
at least introducing the waste material into a first treatment stage to at least partially remove the relatively more volatile component from the waste material by forming at least two portions in which one of the portions is a partially refined portion containing the useful component and the other portion contains the relatively more volatile component;
conveying the partially refined portion to a second treatment stage to further separate the partially refined portion into at least two further portions wherein one of the further portions includes the useful component and the other further portion is substantially free of the useful component so that the partially refined portion is refined into a substantially refined portion;
collecting the substantially refined portion, wherein the substantially refined portion is in a condition that is suitable with or without further treatment for use as an energy source.

3. A method of generating energy from a waste material, including treating the waste material to recover a useful or useable component of the waste material in a condition that is suitable, optionally with further treatment, for use as an energy source, conveying the useful or useable component to an energy generating device or installation and using the useful or useable component to generate energy by operating the energy generating device wherein the treatment of the waste material includes treating a waste material having or containing at least one useful or reusable component and a relatively more volatile component or unwanted component so as to recover the useful or useable component from the waste material by removing the relatively more volatile or unwanted component, including the steps of:
at least introducing the waste material into a first treatment stage to at least partially remove the relatively more volatile component from the waste material by forming at least two portions in which one of the portions is a partially refined portion containing the useful component and the other portion contains the relatively more volatile component;
conveying the partially refined portion to a second treatment stage to further separate the partially refined portion into at least two further portions wherein one of the further portions includes the useful component and the other further portion is substantially free of the useful component so that the partially refined portion is refined into a substantially refined portion;
collecting the substantially refined portion, wherein the substantially refined portion is in a condition that is suitable with or without further treatment for use as an energy source.

4. A method according to any preceding claim, characterised in that the useful or useable material is a hydrophobic material, preferably an oil or oleo material or an oil-like material, more preferably a fat, oil or grease material or solid material, including materials containing such materials.

5. A method according to any preceding claim, in which the hydrophobic material is an oil or oleo material or an oil-like material and the relatively more volatile component or unwanted component is water, water vapor, steam or the like.

6. A method according to any preceding claim, characterised in that the waste material contains up to about 20%, preferably up to about 30%, more preferably up to about 40%, and most preferably up to about 50% of fats, oils, greases and the like.

7. A method according to any preceding claim, characterised in that the waste material includes up to about 5%, preferably up to about 4%, more preferably about 2% of suspended solids.

8. A method according to any preceding claim, characterised in that the waste material includes from about up to 80% or more, preferably up to about 60%, more preferably about 58% and most preferably up to 50% of water.

9. A method according to any preceding claim, characterised in that the first treatment stage is a separation stage involving the use of a separation device for removing water, preferably in the form of steam from the aqueous waste material to partially refine the waste material by forming the at least two portions in which one portion is the partially refined portion having the useful component and the other portion contains water, preferably in the form of steam.

10. A method according to any preceding claim, characterised in that the separation stage includes a separation apparatus or device.

11. A method according to any preceding claim, characterised in that the separation device is a cyclonic evaporator.

12. A method according to any preceding claim, characterised in that the second treatment stage is a second separation stage using a separation apparatus, preferably a cyclonic evaporator, in which the partially refined portion from the first treatment stage is further refined into a substantially refined portion containing the useful component by substantially removing further water, in the form of steam, from the partially refined portion.

13. A method according to any preceding claim, characterised in that the oil or oil-like material is combustible so as to be suitable for use as a fuel or as a component of a fuel or is treatable to form a fuel or as a component of a fuel.

14. A method according to any preceding claim, characterised in that the waste material is at least partially dewatered prior to introduction into the first treatment stage.

15. A method according to any preceding claim, characterised in that the engine using the fuel or fuel component is an internal combustion engine, a compression engine, a hydrogen assisted combustion engine or the like.

16. A method according to any preceding claim, characterised in that the engine is used to generate electricity, heat or power.

17. A method according to any preceding claim, characterised in that the waste material is obtained from manufacturing processes, including food and beverage manufacturing processes, food preparation processes, including restaurant and fast food preparation establishments, and the like.

18. A method according to any preceding claim, characterised in that there is a first auxiliary or secondary separation stage for treating the partially refined portion to remove further water from the portion containing the useful component, preferably in the form of steam.

19. A method according to any preceding claim, characterised in that there is a second auxiliary or secondary separation stage for treating the substantially refined portion to remove further water, preferably in the form of steam from the portion containing the useful component.

20. A method according to any preceding claim, characterised in that at least one, preferably more, more preferably all, of the portions containing water and/or vapor is/are returned to the process for further use in the method in order to conserve energy.

21. An apparatus for carrying out the method of any preceding claim including one or more separators.

22. A combined waste material treatment installation and energy production facility in which the product of the waste treatment installation is used to fuel the energy production facility wherein the fuel is produced by the method of any preceding claim.

23. A method of treating a waste material, substantially as hereinbefore described with reference to the accompanying drawings.

24. An apparatus for carrying out the method of treating a waste material, substantially as hereinbefore described with reference to the accompanying drawings.

25. A combined facility, substantially as herein described with reference to the accompanying drawings.
